(19) United States
(12) Patent Application Publication
(10) Pub. No.: US 2008/0189210 A1
(43) Pub. Date: Aug. 7, 2008

(54) SYSTEM AND METHODS FOR ROAMING SUBSCRIBERS TO REPLENISH STORED VALUE ACCOUNTS

(75) Inventor: Nimit Sawhney, Brookline, MA (US)

Correspondence Address: FOLEY & LARDNER LLP, 111 HUNTINGTON AVENUE, 26TH FLOOR, BOSTON, MA, 02199-7610, US

(73) Assignee: MoreMagic Solutions, Inc.

(21) Appl. No.: 12/026,371

(22) Filed: Feb. 5, 2008

Related U.S. Application Data
(60) Provisional application No. 60/899,570, filed on Feb. 5, 2007.

(51) Int. Cl. G06Q 20/00; G06Q 40/00; G06F 17/10

(52) U.S. Cl. 705/44

(57) ABSTRACT

A system and method allowing a roaming user to credit or debit a prepaid stored value account across international boarders from a foreign retail location using local currency. A roaming user enters into a commercial transaction at the foreign retail location to credit, debit, or otherwise manage the prepaid stored value account, with the credit/debit amount being identified in a first currency. A transaction request received by a foreign merchant is forwarded to a broker, which in turn generates an electronic transaction request directed to a target stored value account managing entity, and performs any currency exchange that may be required. The managing entity applies the purchased credit or debit to the account using a second currency, the credit/debit amount can be determined according to a currency exchange rate between the first and second currencies. Accordingly, a roaming user's transaction can be processed in real time.

### RELATED APPLICATIONS

This application claims the benefit of Provisional Application Ser. No. 60/899,570, filed in the U.S. Patent and Trademark Office on Feb. 5, 2007. The entire teachings of the above application are incorporated herein by reference.

### FIELD OF THE INVENTION

The present invention relates generally to systems and methods that facilitate enhanced services related to prepaid stored value accounts and, more specifically, to systems and methods allowing roaming users to credit or debit stored value accounts.

### BACKGROUND OF THE INVENTION

Top-up generally refers to the process of replenishing, recharging, or adding value to an existing prepaid stored value account. A prepaid stored value account includes secure prepaid accounts that store an amount of money or loyalty points that a consumer has to spend. One such example of prepaid accounts are prepaid minutes commonly used by mobile communications subscribers. For example, a mobile subscriber can create a stored value account in the form of prepaid minutes, to make phone calls, buy ring tones, send text messages, download games, etc. When funds fall below a threshold value or are depleted, additional value can be added to the account through a process referred to as replenishing, reloading, recharging, or topping-up. Value can be added to an existing stored value account by the account holder or in some instances, by a third party.

Recharging a stored value account entails an exchange of an available payment instrument from the subscriber for stored value from the entity managing the prepaid stored value account. A transaction fee may be incurred as well as any applicable taxes, such that the prepaid stored value is less than the exchanged payment by a value corresponding to the combined amount of the fee and any taxes. International roaming users are faced with additional difficulty of having to conduct a transaction with a merchant in a one currency to replenish a prepaid stored value account in another currency. Some telecommunications operators may choose to provide roaming top-up facilities for its customers. However, each telecommunications operator interested in providing such roaming top-up facilities needs to enter into individual agreements (both business as well as technical) with each and every operator it wants to be able to support.

### SUMMARY OF THE INVENTION

The present invention allows a roaming user to credit or debit a prepaid stored value account across international boarders. Advantageously, the roaming user is able to replenish a prepaid stored value account at a foreign retail location using local currency, which differs from home currency used to manage the account.

In one aspect, the invention relates to a process for electronically replenishing a prepaid stored value account. The process includes purchasing through a foreign merchant a credit to a prepaid stored value account. The purchase is made in a first currency, whereas, the prepaid stored value account is managed in a second currency, different from the first. In response to the purchase, the foreign merchant forwards an electronic transaction to a transaction server. The electronic transaction is indicative of the purchase, using a standardized protocol having provisions that identify at least the purchased credit and the prepaid stored value account. The electronic transaction is routed to a managing entity that is responsible for managing the prepaid stored value account. The managing entity then applies the purchased credit to the prepaid stored value account, using the second currency. Thus, the electronic replenishment is accomplished using different currencies without the need for a pre-existing agreement between the merchant and the managing entity.

In another aspect, the invention relates to distributed transaction management system for a roaming subscriber to credit or debit a prepaid stored value account managed by a home entity. The system includes an electronic entry device receiving a request to credit or debit the prepaid stored value account, the credit or debit amount being identified in a first currency. A transaction client portion of a client-server architecture is also provided in communication with the electronic entry device. The transaction client generates an electronic transaction according to a standardized protocol responsive to the request received from the electronic entry device. The transaction includes indicia of at least the transaction amount, the first currency, and the prepaid stored value account. A transaction server portion of the client-server architecture is provided in networked communication with each of the transaction client and the managing home entity. The transaction server receives the electronic transaction and routes the transaction to the managing home entity, which automatically credits or debits the identified prepaid stored value account in a second currency corresponding to the transaction amount.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an exemplary block diagram of different entities participating in roaming top-up transactions in accordance with the principles of the present invention.

FIG. 2 is a block diagram of an embodiment of a top-up transaction broker architecture in accordance with the principles of the present invention.

FIG. 3 is a flow diagram of an embodiment of an roaming top-up process in accordance with the principles of the present invention.

FIG. 4 is a transaction flow diagram of an exemplary transaction request in accordance with the principles of the present invention.

FIG. 5 is a block diagram of an embodiment of a top-up transaction broker architecture in accordance with the principles of the present invention.

### DETAILED DESCRIPTION OF THE PREFERRED EMBODIMENTS

A description of preferred embodiments of the invention follows.

The present invention allows a roaming user to credit (i.e., top-up), debit, or otherwise manage a prepaid stored value account. In preferred embodiments, the roaming user manages a prepaid stored value account across international boarders using foreign currency. The term “top-up” is used to describe the process of recharging a customer's prepaid phone (mobile or landline) account via any available payment instrument like cash, credit card, bank debit, etc. More generally, the present invention is applicable to the process of recharging any kind of prepaid account. A roaming user, or subscriber, in a foreign domain enters into a transaction with a foreign merchant to replenish the existing home prepaid stored value account. The foreign domain can be a different network than a home network, such as VERIZON wireless versus CINGULAR, a different country than a home country, or both a different network and a different country. The roaming subscriber can accomplish the top-up transaction using foreign currency or tender native to the merchant that is different from a home currency used in managing the existing prepaid stored value account. The ability to accomplish such a transaction in a foreign domain using different currencies, without a requirement that the parties to enter into individual agreements (either business or technical) facilitates the transaction from both the consumer's and the merchant's perspective. To the foreign merchant, the transaction is local, being accomplished in a merchant's local currency. To the merchant and the user, the transaction is also local, because the user, or subscriber can enters the appropriate account number or numbers, as would be done for a local transaction. Any currency exchange, message translation, etc. is accomplished behind the scene with respect to the user and the foreign merchant.

As part of the transaction, after an exchange of a payment instrument between the consumer and the foreign merchant in the merchant's local (i.e., foreign) currency, the merchant initiates an electronic transaction with a home, managing entity of the stored value account through an intermediary or broker. The merchant can conduct such transactions with countless stored value account managers, through a single agreement with the broker entity. This agreement addresses any technical and business requirements or restrictions that may be imposed by the broker entity. Likewise, the broker entity enters into individual agreements with one or more stored value account managers, that address any technical and business requirements or restrictions imposed by the account managers, or agreed to between the broker and the individual account managers. In such an arrangement, a roaming user can access any home stored value account through any foreign merchant, as long as individual agreements between the foreign merchant and the broker and between the broker and individual stored value account managers are in place. In some instances, the agreements are highly individualized as my be imposed by a stored value account manager. Alternatively or in addition, the agreements are little or no more than adhering to a predetermine (e.g., standardized) technical and business requirements.

For example, a broker receives an electronic transaction from a foreign merchant using a standard transaction protocol. The electronic transaction is directed toward a targeted home, stored value account managing entity. The broker forwards the received electronic transaction to the target stored value account managing entity in the same or different transaction protocol, as may be required by the target stored value account managing entity. When forwarding in a different protocol, the broker can reformat, or otherwise modify the transaction from one protocol to a another protocol. Directing transactions through the broker entity in this manner facilitates the roaming top-up transaction without any need for any preexisting agreement between the foreign merchant and the stored value account manager. Preferably, the transaction is seamless from the consumer's perspective. More preferably, the transaction is also seamless from the foreign merchant's perspective. Preferably, such transactions are accomplished in “real-time,” or at least in “near real-time.” Such a solution offers value to stored value account managing entities all over the world, especially in markets where there is significant proportion of “prepaid” customers, such as telecom operators.

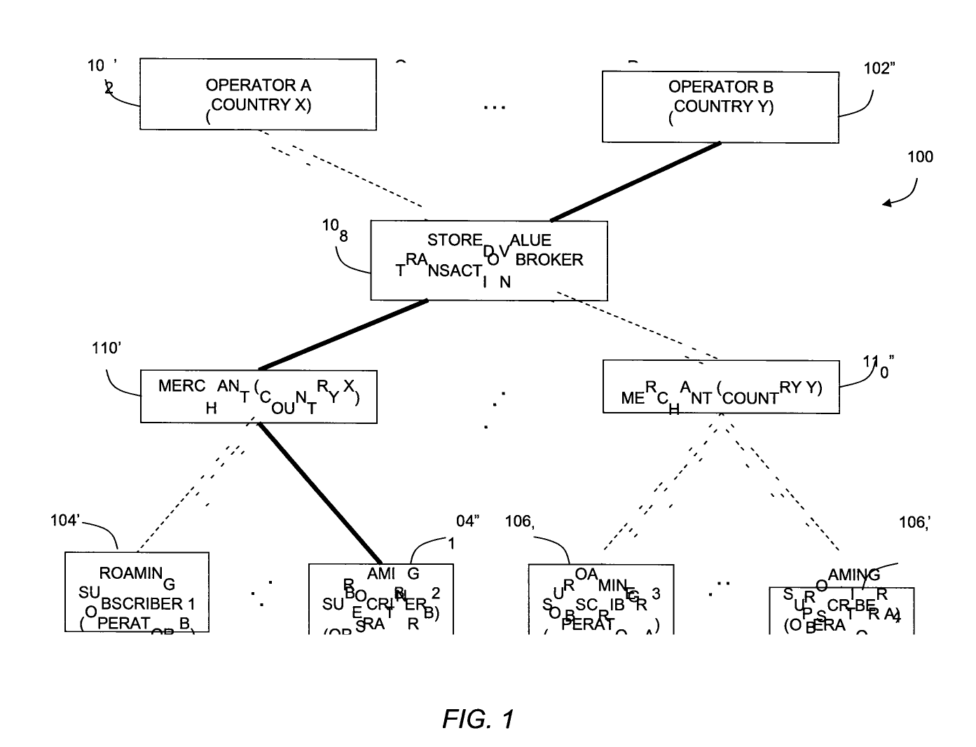

Referring to FIG. 1, different entities involved in an exemplary international, roaming top-up transaction 100 include a first entity responsible for managing stored value accounts. Two exemplary entities are is illustrated and referred to as Operator A 102′ doing business in country X and Operator B 102″ doing business in country Y. The operators 102′, 102″ (generally 102) can be mobile operators that offering mobile services in their respective countries. Roaming consumers, also referred to as roaming subscribers in the mobile communications example, establish stored value accounts with a respective one of the operators 102 corresponding to their home country. In the exemplary embodiment, two roaming subscribers (first Roaming Subscriber 104′ and second Roaming Subscriber 104″, each from country Y) have established stored value accounts with Operator B 102″ also in country Y. Similarly, two other subscribers (third Roaming Subscriber 106′ and a fourth Roaming Subscriber 106″, each from country X) have established stored value accounts with Operator A 102′ also in country X.

When a roaming subscriber is roaming within the home operator's network (e.g., first and second Roaming Subscribers 104′, 104″ (generally 104) within Operator B's network), top-up transactions can be accomplished directly between the subscriber 104 and the operator 102′, 102″. However, when a roaming subscriber 104 is roaming in another operator's network, the transaction requires special handling to ensure that the roaming subscriber's top-up transaction is completed. A broker service 108 is provided between the roaming subscriber 104 and the home operator 102 to accomplish such transactions.

As illustrated, first and second Roaming Subscribers 104′, 104″ (generally 104) can top-up their pre-existing stored value accounts with their home Operator B 102″ using a foreign merchant's top-up facility in foreign country X. The solid line represents an exemplary path of a top-up transaction request. The second Roaming Subscriber 104″ initiates a transaction with a merchant 110′ in Country X. The merchant 110′ exchanges payment instrument with the second Roaming Subscriber 104″ using local currency. The merchant 110′ then generates an electronic transaction directed to the Operator B 102″ through the Top-Up Transaction Broker, or hub 108. The top-up transaction broker 108, in turn, directs the second roaming subscriber's transaction to the intended Operator B 102″ associated with the second Roaming Subscriber's prepaid stored value account, which accomplishes the requested top-up transaction of the account in the subscriber's home currency. Upon successful completion of the transaction, a confirmation message or receipt can be returned from operator B 102″ to the second Roaming Subscriber 104″. In some embodiments, if one or more network endpoints are not available the transaction is immediately rejected.

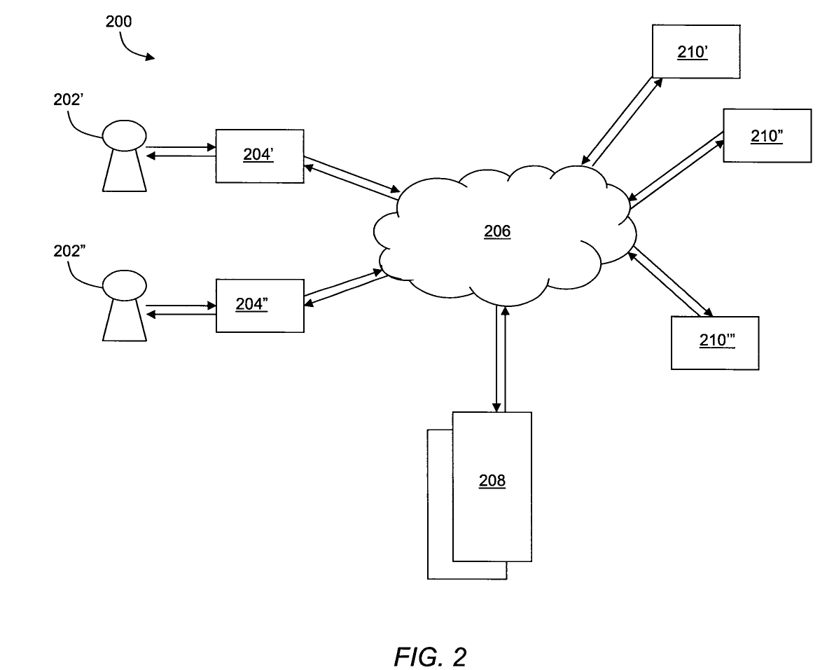

Referring to FIG. 2, an exemplary architecture for providing roaming stored-value account management includes one or more stored value account entities 210′, 210″, 210′″ (generally 210), a broker entity 208, and one or more foreign merchants 204′, 204″ (generally 204). The stored value account entities 210, the broker entity 208, and the foreign merchants 204 are in communication with each other, at least during a transaction, through a network 206. The network 206 can include one or more of a local network, a metropolitan network, a wireless network, a telco network, and a wide area network, such as the Internet. Preferably, merchants 204 are able to communicate with the broker 208 in real time. Likewise, the broker 208 is also able to communicate with the stored value account entities 210, as may be required, in real time. One or more of such communications can be accomplished using established networking protocols, such as TCP/IP.

Roaming users 202′, 202″ (generally 202) can interact directly with foreign merchant 204, such as a kiosk or store in a foreign country to top-up a stored value account entity 210 in their home country. For example, a roaming user 202 requests a top-up transaction from a foreign merchant 204 using local (i.e., foreign) currency. The foreign merchant 204 forwards a transaction request message to the broker entity 208 according to pre-agreed, or at least standardized, terms. The broker entity 208 receives the transaction request message, examines the message to determine the target stored value account entity 210, reformats the message as may be required, and forwards the reformatted transaction request message to the appropriate target stored value account entity 210 according to pre-agreed, or at least standardized terms. The target stored value account entity 210 receives the message and responds accordingly to the request. In at least some instances, the target stored value account entity 210 forwards one or more reply messages to the roaming user 202 originating foreign merchant 204.

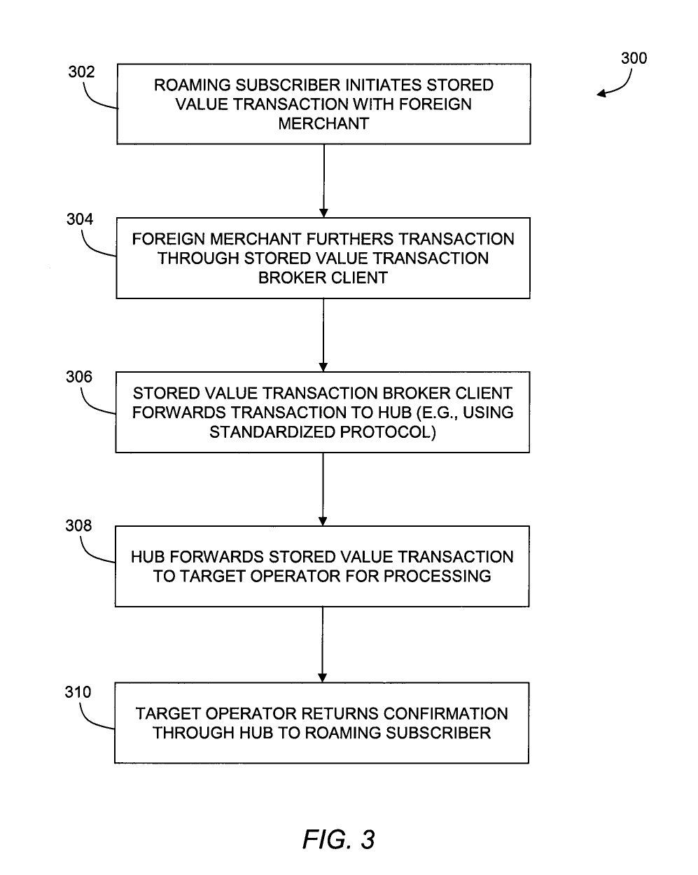

Referring to FIG. 3, a flow diagram of an exemplary process is illustrated for performing a top-up transaction using a different provider's network. At Step 302, a roaming subscriber initiates a top-up transaction through a foreign merchant. At Step 304, the foreign merchant furthers the transaction through a top-up transaction broker client. The top-up transaction broker client prepares a transaction message according to a standardized protocol recognized by the top-up transaction broker. At Step 306, the top-up transaction broker client forwards the standardized transaction to the top-up transaction hub. At Step 308, the top-up transaction broker hub forwards the top-up transaction to the intended target operator for processing. This forwarding step 308 can include reformatting of the top-up transaction request, as required, according to the target operator's preferred transaction format. Processing performed by the receiving prepaid value account manager, or operator, includes performing the requested credit or debit to the stored value account. At Step 310, the target operator returns a confirmation message (i.e., a receipt) through top-up transaction broker hub to the roaming subscriber. The receipt can be routed through the top-up transaction broker, which can reformat the confirmation message as required. Ultimately, the roaming subscriber receives a receipt confirming that the requested top-up transaction has been completed.

In some embodiments, the invention includes one or more of: a standards-compliant universal protocol (referred to herein as the Roaming Broker Communications Protocol (RBCP)); real-time carrier provisioning; real-time roaming top-up transaction routing and processing; and high availability and disaster recovery.

The standards compliant universal protocol provides a standard, easy-to-deploy protocol, which enables any IP enabled network infrastructure to communicate with the top-up transaction broker securely over a network, such as a virtual private network (VPN), or a Wide Area Network (WAN), such as the Internet, via the standards-compliant universal protocol. One such standards-compliant universal protocol is compliant with Simple Object Access Protocol (SOAP). SOAP allows for exchange of extensible Mark-up Language (XML)-based messages over a computer network, normally using HyperText Transfer Protocol (HTTP).

SOAP also provides a basic messaging framework upon which additional abstract layers can be built. SOAP supports different types of messaging patterns. One such messaging pattern is the Remote Procedure Call (RPC) pattern. This allows one network node (e.g., a client) to send a request message to another network node (e.g., a server), with the server immediately sending a response to the client.

Real-time carrier provisioning enables an account managing entity, such as a telecom carrier, to register and provision itself with the top-up transaction broker via a roaming broker communication protocol (RBCP) providing single-point network accessibility to the various other carriers participating in the service within minutes without having to connect to each individual carrier separately.

Real-time, roaming top-up transaction routing and processing enables a roaming customer (e.g., having preestablished a stored value account with carrier A in country X) to walk into a store of a carrier B in a country Y and recharge his/her prepaid mobile phone account by simply providing the complete phone number and the payment. The payment includes the amount to be added to the stored value account as well as any service and/or taxes that apply. The merchant then processes the transaction as if the customer were a local customer and without having to be aware of the international transactions occurring in the background.

Preferably, the system is implemented to have high availability and disaster recovery capabilities. High availability and disaster recovery capabilities support virtual round-the-clock access. The broker architecture provides a very high level of service availability and reliability by providing a network of inter-communicating nodes that are geographically disbursed in different corners of the world. Such a globally disburse network is better able to respond to an outage in one region by routing traffic through one or more different regions. Virtually round-the-clock network connectivity (e.g., over TCP/IP) between top-up transaction and the various participating carriers is also essential to success of the system. Without this, parts of the service will fail even with the distributed high availability configuration model in place.

Providing roaming top-up transaction routing and processing in real-time, depends upon stored value account managers (i.e., mobile carrier) providing real-time carrier provisioning. A standards-compliant universal protocol, such as SOAP, can be used to enable real-time carrier provisioning, and real-time roaming top-up transaction routing and processing. For example, RBCP can be used to facilitate real-time carrier provisioning and real-time roaming top-up transaction broker routing and processing to work.

More generally, the invention facilitates the processing of any kind of transaction between multiple parties, in which the parties do not wish to enter into multiple agreements with various partners and would rather route everything via a single entity i e., the RBroker.

Conceptually speaking, the top-up transaction broker could also be acting as a transaction clearing house though the “type” of transaction is different.

As described herein, a home stored value account can be credited or debited through a roaming transaction. The roaming transactions can be accomplished using predefined source parameters, such as those listed in Tables 1 and 3. Source identifiers are provisioned in one or more roaming broker databases before they can send top-up transactions. In some embodiments, consumers receive a confirmation upon successful completion of a transaction. The confirmations can include an automatically generated short message service (SMS) message subject to the various inter-carrier SMS delivery agreements.

The parameters in Table 1 can be used in requesting a credit top-up transaction. A transaction directed to a stored value account provider, or operator, generally includes identifiers for the consumer (i.e., roaming subscriber) and merchant. Additional identifiers can be included, such as a source merchant's transaction ID, reference, or tracking number. Another parameter can be included to identify the currency used by the merchant (i.e., a foreign currency that may be different than a home currency, in which the stored value account is managed). For this value, a predefined value, such as a valid ISO currency code can be supplied. Other parameters can be used to identify one or more of a tax related to the consumer's transaction with the merchant, a timestamp related to the time of the transaction, and an optional promotion flag that can be used to identify a transaction as being subjected to a promotional rate.

In some embodiments, a transaction request results in one or more return messages directed to the roaming subscriber. For example, in response to a successful transaction the stored value account manager can send a response message to the roaming user in the form of a receipt that identifies the new balance amount resulting from the top-up transaction. The response can include a transaction identifier for tracking and identification purposes. An unsuccessful transaction will result in a response indicating such and also providing a resulting error code, and/or error string.

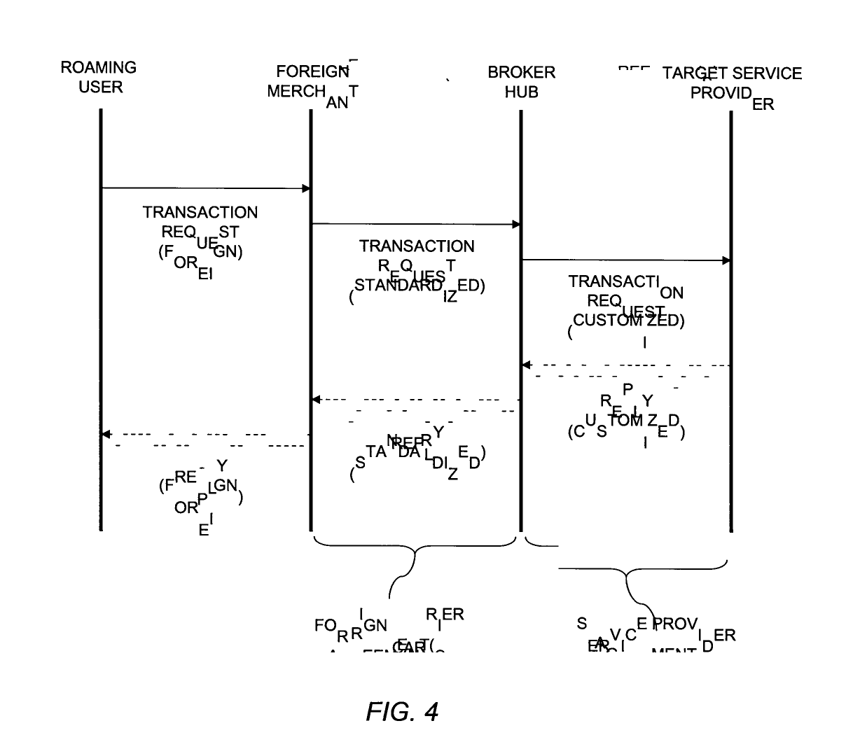

An exemplary message transfer is illustrated in FIG. 4. A roaming user requests a transaction, such as a top-up transaction from a foreign merchant. This request may be in person at a kiosk in the foreign country, or online through a Web-accessible kiosk. In response to the roaming user's transaction request, the foreign merchant generates an electronic transaction request directed to a broker entity. The merchant-generated transaction request can conform to a predetermined, or standardized format acceptable to the broker entity. This transaction may be subject to a pre-established foreign merchant agreement with the broker entity. The broker entity receives the merchant generated transaction request, determines a target stored value account managing entity, reformats and/or regenerates a transaction request message, as may be required, conforming to a predetermined, or standardized format acceptable to the target stored value managing entity. This transaction may be subject to a pre-established broker entity agreement with the target stored value account managing entity. The target stored value account managing entity performs the requested transaction, adjusting a balance of the stored value account as may be necessary. In some embodiments, the target stored value account managing entity sends are response message to the roaming user, such as a confirmation or updated account balance, through the broker in a similar manner.

The broker can pre-purchase, or otherwise commit to a minimum amount of stored value, at a bulk discount rate. As such, the broker can collect any difference between retail stored value amount and the bulk discount rate. Alternatively or in addition, the broker can perform a currency exchange function between a foreign merchant and a home stored value account manager entity. In some embodiments, the broker can apply an exchange rate that includes a surcharge for the exchange service, collected by the broker entity. Thus, each of the foreign merchant and the home stored-value account managing entity perceive the transaction in their respective currencies.

TABLE 1
Exemplary Parameters to Credit a Stored Value Account

| Parameter Name | Type | Direction | Valid Value | Mandatory | Description |
|---|---|---|---|---|---|
| CustomerID | String | In | | Yes | Fully qualified phone number of the |
| | | | | | beneficiary customer |
| SourceID | String | In | | Yes | Source Merchant's ID |
| SourceTxnID | String | In | | Yes | Source Merchant's Transaction ID |
| | | | | | or Reference Number or Tracking |
| | | | | | Number |
| CreditAmount | String | In | String | Yes | Actual amount to be added to the |
| | | | representation | | beneficiary's prepaid account |
| | | | of an amount | | |
| | | | value greater | | |
| | | | than 0 | | |
| Currency | String | In | Valid ISO code | Yes | The ISO code of the currency in |
| | | | | | which the amount is being sent by |
| | | | | | the source |
| Tax | String | In | 0 is allowed | Yes | Amount of tax deducted at source, if |
| | | | | | any |
| Timestamp | String | In | | Yes | Source's timestamp in the format - |
| | | | | | YYYYMMDDHH24MISS |
| PromoFlag | String | In | 0, 1 are allowed | Yes | 0 - No promotion in effect (default) |
| | | | at this time | | 1 - Promotion defined previously via |
| | | | | | the ConfigureNetwork method |

RESPONSE ON TRANSACTION SUCCESS

| | | | | |
|---|---|---|---|---|
| NewBalance | Double | Out | Yes | New balance of the beneficiary after |
| | | | | the successful completion of the |
| | | | | transaction |
| RoamingTxnID | String | Out | Yes | Transaction ID generated by the |
| | | | | MM Roaming Broker |

RESPONSE ON TRANSACTION FAILURE

| | | | | |
|---|---|---|---|---|
| FaultCode | String | Out | Yes | Fault error code |
| FaultString | String | Out | Yes | Fault error message |

For instances in which the credit top-up transaction is unsuccessful, a return message to the roaming subscriber can include one or more error codes. The parameters in Table 2 represent exemplary error codes generated in response to an unsuccessful attempt to perform a credit top-up transaction. The error codes provide detail as to the nature of the error to assist parties in accomplishing a successful transaction. As illustrated, the codes can be numeric codes indicative of a particular error.

TABLE 2
Exemplary Error Codes for Unsuccessful
Attempt to Credit a Stored Value Account

| Code | Description |
|---|---|
| 22010 | Invalid or Missing CustomerID |
| 22020 | Invalid or Missing SourceID |
| 22021 | SourceID not permitted to add credit |
| 22030 | Invalid or Missing SourceTxnID |
| 22040 | Invalid or Missing Amount |
| 22050 | Invalid or Missing Currency Code |
| 22060 | Invalid or Missing Tax |
| 22070 | Invalid or Missing Timestamp |
| 22080 | Invalid Flag |
| 22110 | Remote prepaid system timeout |
| 22120 | Remote prepaid system error <code> |
| 22130 | Remote prepaid system is offline, not available |
| 22210 | Cannot locate home network for CustomerID |
| 22310 | Duplicate transaction detected |
| 22999 | Unknown error <additional message, if any> |

The parameters in Table 3 are similar to those described above except that they relate to a debit transaction, rather than a credit top-up transaction.

For instances in which the debit top-up transaction is unsuccessful, one or more error codes can also be provided. The parameters in Table 4 represent exemplary error codes generated in response to an unsuccessful attempt to perform a debit top-up transaction. The error codes provide detail as to the nature of the error to assist parties in accomplishing a successful transaction. As illustrated, the codes can be numeric codes indicative of a particular error.

TABLE 3
Exemplary Parameters to Debit a Stored Value Account

| Parameter Name | Type | Direction | Valid Value | Mandatory | Description |
|---|---|---|---|---|---|
| CustomerID | String | In | | Yes | Fully qualified phone number of the |
| | | | | | beneficiary customer |
| SourceID | String | In | | Yes | Source Merchant's ID |
| SourceTxnID | String | In | | Yes | Source Merchant's Transaction ID or |
| | | | | | Reference Number or Tracking |
| | | | | | Number |
| DebitAmount | String | In | Lesser than 0 | Yes | Actual amount to be removed from |
| | | | | | the beneficiary's prepaid account |
| Currency | String | In | Valid ISO code | Yes | The ISO code of the currency in |
| | | | | | which the amount is being sent by the |
| | | | | | source |
| Timestamp | String | In | | Yes | Source's timestamp in the format - |
| | | | | | YYYYMMDDHH24MISS |
| ReasonCode | String | In | 01-07 only | Yes | 01 - Customer account termination |
| | | | | | 02 - Payment failure at source |
| | | | | | 03 - Network agreement termination |
| | | | | | 04 - Fraud at source |
| | | | | | 05 - Customer no longer roaming |
| | | | | | 06 - Duplicate transaction |
| | | | | | 07 - Any other reason |

RESPONSE ON TRANSACTION SUCCESS

| | | | | |
|---|---|---|---|---|
| NewBalance | Double | Out | Yes | New balance of the beneficiary after |
| | | | | the successful completion of the |
| | | | | transaction |
| RoamingTxnID | String | Out | Yes | Transaction ID generated by the MM |
| | | | | Roaming Broker |

RESPONSE ON TRANSACTION FAILURE

| | | | | |
|---|---|---|---|---|
| FaultCode | String | Out | Yes | Fault error code |
| FaultString | String | Out | Yes | Fault error message |

TABLE 4
Exemplary Error Codes for Unsuccessful
Attempt to Debit a Stored Value Account

| Code | Description |
|---|---|
| 23010 | Invalid or Missing CustomerID |
| 23020 | Invalid or Missing SourceID |
| 23021 | SourceID not permitted to remove credit |
| 23030 | Invalid or Missing SourceTxnID |
| 23040 | Invalid or Missing Amount |
| 23050 | Invalid or Missing Currency Code |
| 23060 | Invalid or Missing ReasonCode |
| 23070 | Invalid or Missing Timestamp |
| 23110 | Remote prepaid system timeout |
| 23120 | Remote prepaid system error <code> |
| 23130 | Remote prepaid system is offline, not available |
| 23210 | Cannot locate home network for CustomerID |
| 23310 | Duplicate transaction detected |
| 23999 | Unknown error <additional message, If any> |

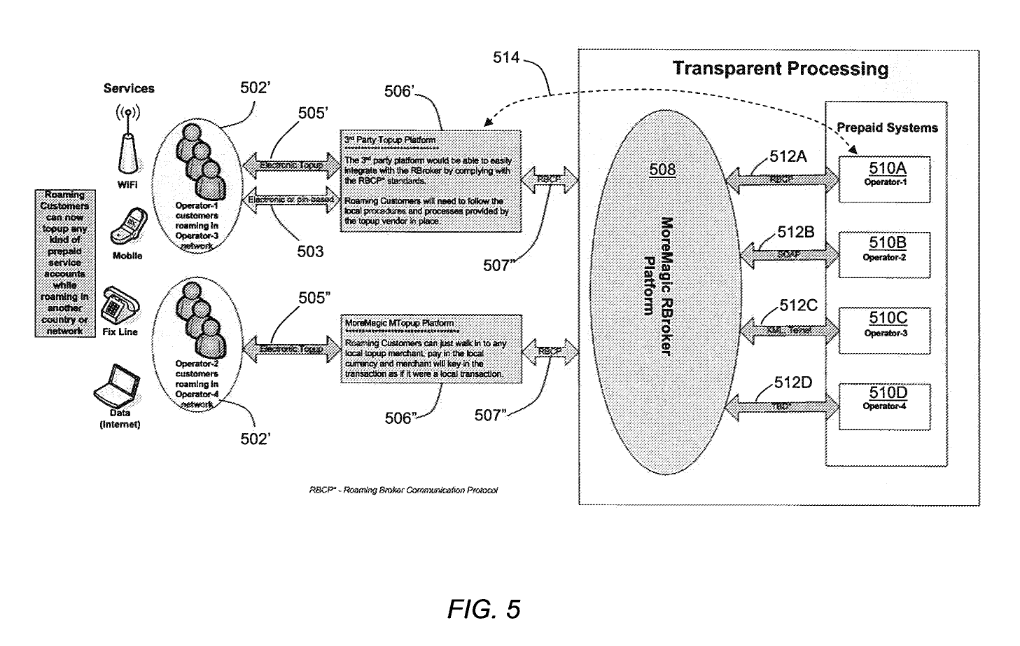

The top-up transaction broker is a distributed transaction management system designed to seamlessly process inter-carrier top-up transactions worldwide. Referring to FIG. 5, roaming subscribers 502′, 502″ can top-up different types of prepaid service accounts while roaming in another country or network. Types of service accounts include WiFi, mobile telephone, fixed or landline telephone, and data (e.g., Internet). First roaming subscribers 502′ are home customers of operator-1 510A roaming in a foreign operator's network. The first roaming subscribers 502′ initiate a top-up transaction with a local merchant 506′ in the foreign operator's network. The local merchant 506′ may include a third party top-up platform that communicates with a top-up transaction broker 508 through a standardized protocol 507′. The third party top-up platform 506′ receives an electronic transaction request from the roaming user 502′ and in response generates one or more transaction request messages in a suitable format for the top-up transaction broker 508. The top-up transaction broker 508 then communicates with one or more prepaid account management systems 510A, 510B, 510C, 510D (generally 510) hosted by respective operators. In some embodiments, the top-up transaction broker 508 communicates with the different prepaid account management systems 510 using an operator preferred transaction protocol. Examples of such protocols include SOAP, XML, telnet, the standardized protocol of the top-up transaction broker 508, and other standardized and proprietary protocols.

Alternatively or in addition, roaming subscribers 502′, 502″ can top-up different types of prepaid service accounts while roaming in another country or network through a local merchant 506′, 506″ in networked communication with a top-up transaction broker 508. For example, the second operator customers 502″ roaming in operator 4 network can initiate an electronic top-up transaction using a top-up platform 506″ also in communication with the top-up transaction broker 508.

In some embodiments, the top-up transaction broker 508 acts as a central hub for all participating stored value account providers, such as the telecom carriers in the exemplary embodiment, and intelligently routes top-up transaction requests initiated by roaming subscribers 502′, 502″ (from a location typically outside their home country or state) to the appropriate home prepaid account management system, or network thereby saving both the roaming and the home carriers from the trouble of setting up complicated networking arrangements between each other (and indeed all the hundreds of telecom carriers all around the world) in order to support the roaming top-up functionality for their customers. A distributed infrastructure includes various top-up transaction broker nodes installed around the world to provide a high degree of performance and reliability. Multiple broker nodes can be used for one or more of load sharing, load balancing, and bandwidth management. For example, a broker node in Asia can handle Asian traffic; whereas, a North American broker node can handle one or more of North American traffic, South American traffic, European traffic, African traffic, and Australian traffic. Geographically dispersed broker nodes improve reliability, by providing overlapping coverage in geographically remote regions, such that compromise or failure of one or more broker nodes can be redirected to other nodes. The broker node itself can be a computer system, such as a network server. A broker server can include local storage, and in some embodiments, remote, or networked storage. The computer includes an operating system, such as any of the MICROSOFT WINDOWS family, LINUX and its derivatives, UNIX, MAC OS, MAC OS X, and hosts one or more additional software applications configured to interpret and generate transaction messages with all interconnected entities. The software may include modules, elements, or processes related to such various related functions as network communications, currency exchange, billing, taxation. The broker server may include one or more of a local and remote terminals for access and management of the broker server. In some embodiments, the broker nodes themselves are fault tolerant, optionally including one or more redundant components.

Although the exemplary embodiments described top-up type transactions, other types of electronic stored value account transactions are anticipated, such as account debits, account provisioning (initially loading the card), and general account management, such as transfer of credits to another account (e.g., a secondary card holder), reconciliation, checking balance, and temporarily blocking account access. Stored value accounts can include closed system cards, such as gift cards, semi-closed cards, such as geographically restricted pre-paid cards, and open system purchasing cards, otherwise known as stored value credit cards. Although the term cards is used in relation to many of the exemplary stored value accounts, an actual card is not necessary. As long as a user or subscriber has access to a stored value account, through a card, an account number and, and any other indicia of identification or account ownership, such as a personal identification number (PIN). In some embodiments, roaming users can manage their prepaid card account using a mobile device, such as a mobile phone, a BLACKBERRY, or a WiFi enabled portable computer.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for electronically replenishing a prepaid stored value account, comprising:
purchasing through a foreign merchant in a first currency a credit to a prepaid stored value account, the prepaid stored value account being managed in a second currency, different from the first;
forwarding from the foreign merchant an electronic transaction indicative of the purchase to a transaction server, the electronic transaction using a standardized protocol having provisions identifying at least the purchased credit and the prepaid stored value account;
routing the electronic transaction to a managing entity responsible for managing the prepaid stored value account; and
applying the purchased credit in the second currency to the prepaid stored value account, wherein the electronic replenishment is accomplished using different currencies without any requirement for a pre-existing agreement between the merchant and the managing entity.

2. The method of claim 1, wherein the act of applying the purchased credit occurs in real time with respect to the act of purchasing the credit.

3. The method of claim 1, further comprising translating the electronic transaction using a standardized protocol to a translated electronic transaction, compliant with transaction protocol requirements of the managing entity responsible for managing the prepaid stored value account.

4. The method of claim 1, further comprising sending a reply through the foreign merchant confirming credit of the prepaid stored value account.

5. The method of claim 1, wherein the Standardized Protocol Comprises Simple Object Access Protocol (SOAP).

6. The method of claim 1, wherein the foreign merchant forwards the electronic transaction using a client application.

7. The method of claim 1, further comprising exchanging a first currency usable with the foreign merchant with a second currency usable with the managing entity responsible for managing the prepaid stored value account.

8. The method of claim 7, wherein exchanging a first currency with a second currency comprises automatically calculating the purchased credit in a second currency by multiplying the credit purchased in a first currency by a currency exchange rate between the first and second currencies.

9. The method of claim 1, wherein the acts of purchasing, forwarding, routing, and applying are performed substantially in real time.

10. A distributed transaction management system for a roaming subscriber to credit or debit a prepaid stored value account managed by a home entity, comprising:
an electronic entry device receiving a request to credit or debit the prepaid stored value account, the credit or debit request identified in a first currency;
a transaction client in communication with the electronic entry device, generating an electronic transaction in a standardized protocol responsive to the received request, the transaction including indicia of at least the transaction amount, the first currency, and the prepaid stored value account; and
a transaction server in networked communication with each of the transaction client and the managing home entity, the transaction server receiving the electronic transaction and routing the transaction to the managing home entity, which automatically credits or debits the identified prepaid stored value account in a second currency corresponding to the transaction amount.

11. The system of claim 10, wherein the electronic entry device is selected from the group consisting of: a computer terminal; a cash register; an ATM; and a mobile phone.

12. The system of claim 10, wherein the transaction client is hosted on a third-party platform.

13. The system of claim 10, wherein the managing entity is a mobile service provider, the prepaid stored value account usable to purchase one or more of phone calls, ring tones, text messages, downloadable images and games.

14. The system of claim 10, wherein the transaction server is fault tolerant.

15. The system of claim 10, wherein the transaction server comprises a plurality of redundant transaction servers.

16. The system of claim 10, wherein networked communication comprises using the Internet.

17. The system of claim 10, wherein the transaction server is a LINUX server.

18. A system for electronically replenishing a prepaid stored value account, comprising:
means for purchasing through a foreign merchant in a first currency a credit to a prepaid stored value account, the prepaid stored value account being managed in a second currency, different from the first;
means for forwarding from the foreign merchant an electronic transaction indicative of the purchase to a transaction server, the electronic transaction using a standardized protocol having provisions identifying at least the purchased credit and the prepaid stored value account;
means for routing the electronic transaction to a managing entity responsible for managing the prepaid stored value account; and
means for applying the purchased credit in the second currency to the prepaid stored value account, wherein the electronic replenishment is accomplished using different currencies without any requirement for a pre-existing agreement between the merchant and the managing entity.
